(19) United States
(12) Patent Application Publication
(10) Pub. No.: US 2020/0391463 A1
(43) Pub. Date: Dec. 17, 2020

(54) TURN-UP DEVICE AND TIRE BUILDING DRUM COMPRISING SAID TURN-UP DEVICE

(71) Applicant: VMI HOLLAND B.V., Epe (NL)

(72) Inventors: Martin DE GRAAF, Epe (NL); Dave PAPOT, Epe (NL)

(21) Appl. No.: 16/964,012

(22) PCT Filed: Jan. 2, 2019
(86) PCT No.: PCT/NL2019/050001

§ 371 Date: Jul. 22, 2020

(30) Foreign Application Priority Data
Jan. 26, 2018 (NL) 2020325

(51) Int. Cl. B29D 30/32; B29D 30/26

(52) U.S. Cl. CPC B29D 30/32; B29D 2030/3264; B29D 30/26

(57) ABSTRACT

The invention relates to a turn-up device for a tire building drum and a tire building drum comprising said turn-up device, wherein the turn-up device comprises turn-up arms distributed in a circumferential direction about a central axis for turning-up tire components on the tire building drum, wherein the turn-up device comprises rolling elements extending in the circumferential direction between the turn-up arms for rolling over the tire components during the turning-up, wherein the rolling elements are flexible about the central axis, wherein the turn-up device further comprises an annular support element extending in the circumferential direction along and supported by each of the turn-up arms, wherein the annular support element extends in the circumferential direction through each of the rolling elements and is flexible about the central axis, wherein the rolling elements are rotatable with respect to the turn-up arms about the annular support element.

### BACKGROUND

The invention relates to a turn-up device and a tire building drum comprising said turn-up device.

EP 2 204 277 A1 discloses a turn-up device which is capable of turning up both width-end portions of a body ply by an even pressing force without leaving any spaces in the circumference even in the case of being high in turn-up height. To this end, a plurality of arm components are circumferentially arranged to be movable in the axial direction of an operating shaft and to be pivotable radially of the operating shaft; guide members are respectively supported at both sides on an end portion of each arm component to be rotatable about an axis parallel to a pivot axis of each arm component; coil springs are interposed in respective spaces each between two guide members respectively supported on the arm components adjoining; both end portions of the coil springs are respectively connected to the guide members. The outer surfaces of the coil springs are covered with elastic members which are rich in elasticity.

### SUMMARY OF THE INVENTION

A disadvantage of the known turn-up device is that the coil springs are supported only at the guide members. Hence, the coil springs need to be relatively stiff to ensure a uniform pressure distribution along the axial length thereof. Such a stiff coil spring can cause imprints in the tire material that is being turned-up. To increase the rigidity of the coil springs, it is further known from EP 2 204 277 A1 to use guide portions that protrude from the respective guide members to guide the opposite end portions of the coil spring over the axial lengths of the guide portions. However, these rigid guide portions cause deformations in the natural curvature of the coil springs, which again negatively impacts the uniformity of the pressure distribution and ultimately, the quality of the turn-up.

It is an object of the present invention to provide a turn-up device and a tire building drum comprising said turn-up device, wherein the quality of the turn-up can be improved.

According to a first aspect the invention provides a turn-up device for a tire building drum, wherein the turn-up device comprises a plurality of turn-up arms distributed in a circumferential direction about a central axis and pivotable in a radial direction perpendicular to the central axis for turning-up tire components on the tire building drum, wherein the turn-up device comprises a plurality of rolling elements extending in the circumferential direction between the plurality of turn-up arms for rolling over the tire components during the turning-up, wherein the rolling elements are flexible about the central axis, wherein the turn-up device further comprises an annular support element extending in the circumferential direction along and supported by each of the plurality of turn-up arms, wherein the annular support element extends in the circumferential direction through each of the plurality of rolling elements and is flexible about the central axis, wherein the plurality of rolling elements are rotatable with respect to the plurality of turn-up arms about the annular support element.

The annular support element can form a continuous, yet flexible support for each the plurality of rolling elements between the plurality of turn-up arms. The flexibility of the annular support element about the central axis still allows for the plurality of rolling elements supported thereon to adapt to changes in curvature as a result of the diameter expansion or contraction of the turn-up device during the turning-up. Hence, the rolling elements can be pressed more uniformly on the tire components, thereby improving the quality of the turn-up.

In a preferred embodiment the annular support element is stretchable in the circumferential direction from a contracted state to a stretched state, wherein the annular support element is biased to contract from the stretched state to the contracted state. The biased annular support element can thus exert a radially inward force directly on the plurality of rolling elements, which in turn may cause the plurality of rolling elements to more uniformly press onto the tire components during the turn-up. Moreover, provided that the bias is strong enough, the annular support element could serve as a biasing element to return the turn-up arms to an arms-down position. The annular support element could thus replace one or more of the conventional return springs that are typically arranged around the turn-up arms for said purpose.

In a further embodiment the plurality of rolling elements are expandable in the circumferential direction from a compressed state to an expanded state. Hence, each of said rolling elements is biased to expand from the compressed state as soon as the spacing between the turn-up arms increases as a result of the turning-up. Consequently, the rolling elements can span the variable spacing between the turn-up arms in the circumferential direction.

In a further embodiment the annular support element is an inner spring, preferably an inner coil spring. The resilient characteristics of a spring, in particular a coil spring, can provide an advantageous interaction between the annular support element and the plurality of rolling elements to ensure a uniform pressure distribution.

More preferably the inner coil spring comprises a coiled wire with a circular cross section. The plurality of rolling elements can rotate more easily about an outer surface of the inner coil spring that is formed by a circular wire. Moreover, the plurality of rolling elements may shift more easily in the circumferential direction over an outer surface of the inner coil spring that is formed by a circular wire, for example when the inner coil spring expands at a different rate than the plurality of rolling elements.

In a further embodiment the plurality of rolling elements are outer springs, preferably outer coil springs.

More preferably, the outer coil springs comprises a coiled strip having a quadrilateral or substantially quadrilateral cross section. Such a quadrilateral cross section can result in a substantially cylindrical outer surface of the outer coil springs, in particular when they are compressed or contracted in the circumferential direction.

Most preferably, the coiled strip has a rectangular or substantially rectangular cross section. When a rectangular cross section is chosen, the rigidity of the outer coil spring in the radial direction and the axial direction can be different. For example, the outer coil spring may be stronger in the radial direction, for pressing purposes, than in the axial direction. The axial strength may then be derived from the annular support element, while the outer coil springs themselves can be relatively weak and flexible.

In a further embodiment the annular support element is an inner coil spring having a first coil direction, wherein the plurality of rolling elements are outer coil springs having a second coil direction opposite to the first coil direction. By providing the inner coil spring and the outer coil springs with opposite coiling directions, it can be prevented that the windings of the coil springs engage each other.

In an alternative embodiment the plurality of rolling elements are wave springs. The spacing between the windings of a wave spring can be reduced considerably, thus resulting in a more consistent outer surface of the rolling elements for pressing. Additionally, or alternatively, wave springs can be expanded over a larger distance in the circumferential direction than coil springs, thus allowing for a greater diameter increase during the turn-up.

In a further alternative embodiment, each rolling element comprises a plurality of bearings and a plurality of intermediate springs interconnecting said plurality of bearings, wherein the plurality of bearings are arranged for rotatably supporting the respective rolling element on the annular support element. By providing bearings, the plurality of rolling elements can rotate with respect to the annular support element with reduced friction.

In a preferred embodiment thereof the intermediate springs have windings and a pitch between said windings, wherein each bearing has a width in an axial direction tangent to the circumferential direction, wherein said width is at least equal to or double the pitch of the intermediate springs. Hence, the bearings can be supported more reliably on the annular support element, in particular when said annular support element is a coil spring with a pitch that is smaller than the width of said bearings.

In a first embodiment thereof the plurality of bearings has a first diameter and the plurality of intermediate springs has a second diameter equal to or larger than the first diameter. In other words, the intermediate springs are flush with or (slightly) at the outside with respect to the bearings and contact the tire components. Each bearing may be provided with a small flange for retaining the intermediate springs on the outside thereof.

In a second, alternative embodiment thereof the plurality of bearings has a first diameter and the plurality of intermediate springs has a second diameter smaller than the first diameter. In contrast to the previous embodiment, now the bearings extend to a diameter larger than the diameter of the intermediate springs and can thus form the outer surface of the rolling elements that contacts the tire component. The intermediate springs thus merely serve as a flexible connection between the bearings when the plurality of rolling elements are expanded or stretched in the circumferential direction.

In each of the previously discussed embodiments, the bearings and the intermediate springs may be manufactured from a single piece, i.e. by added manufacturing techniques such as 3D printing which are known per se.

In a further embodiment the turn-up device further comprises a separator that extends around the annular support element and separates the annular support element from the plurality of rolling elements. The separator can prevent that the plurality of rolling elements engage the annular support element, e.g. when both are formed as coil springs. The separator can be an elastic encapsulation, e.g. a shrink foil or a shrink sleeve.

In another embodiment each turn-up arm has a first end, a second end and an arm body extending in a longitudinal direction between the first end and the second end, wherein the turn-up arm is arranged to be pivotable in the radial direction about the first end, wherein the annular support element is supported by each of the plurality of turn-up arms at or near their respective second ends. By placing the annular support element as close as possible to the far ends of the turn-up arms with respect to the first end, the moment arm about the first end can be maximized. Consequently, the biasing force of the annular support element on the rolling elements for pressing the plurality of rolling elements firmly against the tire components can be optimized.

According to a second aspect the invention provides a tire building drum comprising the turn-up device according to any one of the aforementioned embodiments. Said tire building drum consequently has the same technical advantages as the turn-up device according to the aforementioned embodiments.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows a side view of a tire building drum with a turn-up device according to a first embodiment of the invention;

FIG. 2 shows a cross section of the turn-up device according to the line II-II in FIG. 1;

FIG. 3 shows a cross section of the turn-up device according to FIG. 2 in an expanded state;

FIG. 4 shows a top view of the turn-up device according to FIG. 3 in the expanded state;

FIGS. 5 and 6 show top views of alternative turn-up devices according to a second embodiment and a third embodiment, respectively, of the invention; and

FIGS. 7, 8 and 9 show a cross section of a further alternative turn-up device according to a fourth, fifth and sixth embodiment of the invention, respectively.

### DETAILED DESCRIPTION OF THE INVENTION

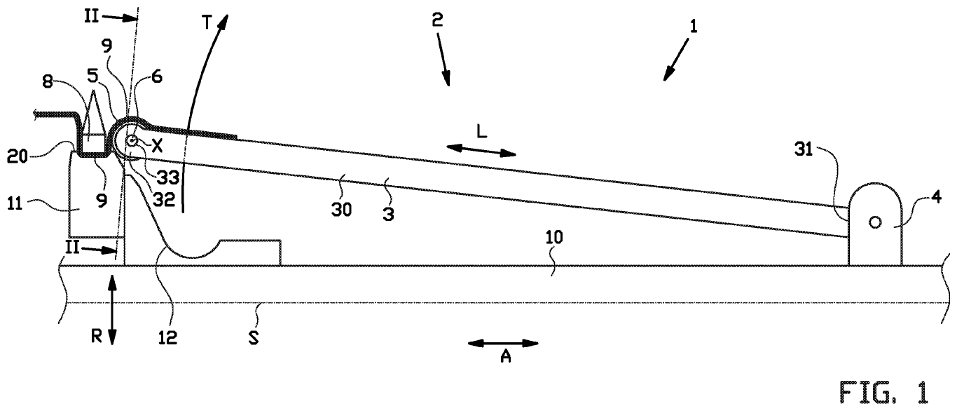

FIG. 1 shows a tire building drum 1 for building or forming a tire out of one or more tire components 9. Said tire building drum 1 comprises a drum shaft 10 that defines a central axis S. The drum shaft 10 extends in an axial direction A parallel to said central axis S. The tire building drum 1 further comprises a bead-lock 11 for locking the position of a bead 8 relative to the tire components 9 in a manner known per se.

As shown in FIG. 1, the tire building drum 1 further comprises a turn-up arm 3 which is exemplary for a plurality of turn-up arms 3 which are distributed in a circumferential direction about the central axis S. FIG. 1 only shows a section of the tire building drum 1, in particular only the top half of one of the drum halves. Consequently, only one of the turn-up arms 3 is shown. The plurality of turn-up arms 3 are slidably supported on the drum shaft 10 through a common arm support 4. This is typically a ring-shaped arm support 4 that is fitted to the drum shaft 10 to be slidable in the axial direction S towards and away from the bead-lock 11. As a result of a movement of the arm support 4 towards the bead-lock 11, the plurality of turn-up arms 3 are pivotable in a turn-up movement T with a component in a radial direction R perpendicular to the central axis S for turning-up the tire components 9 around the bead 8 that is held at the bead-lock 11. In this exemplary embodiment, the tire building drum 1 further comprises a run-on surface 12 for guiding the plurality of turn-up arms 3 up and over the bead 8 at the bead-lock 11.

Each turn-up arm 3 has a first end 31, a second end 32 and an arm body 30 extending in a longitudinal direction L between the first end 31 and the second end 32. The first end 31 is hingably connected to the arm support 4 such that the respective turn-up arm 3 is pivotable about said first end 31 in the radial direction R. The second end 32 is a free, distal or terminal end with respect to the first end 31.

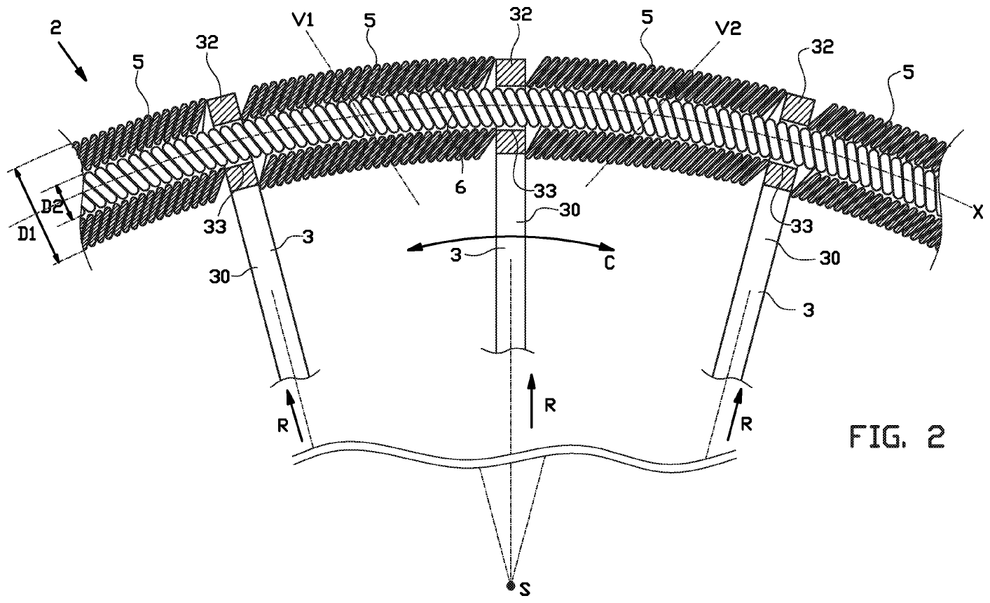

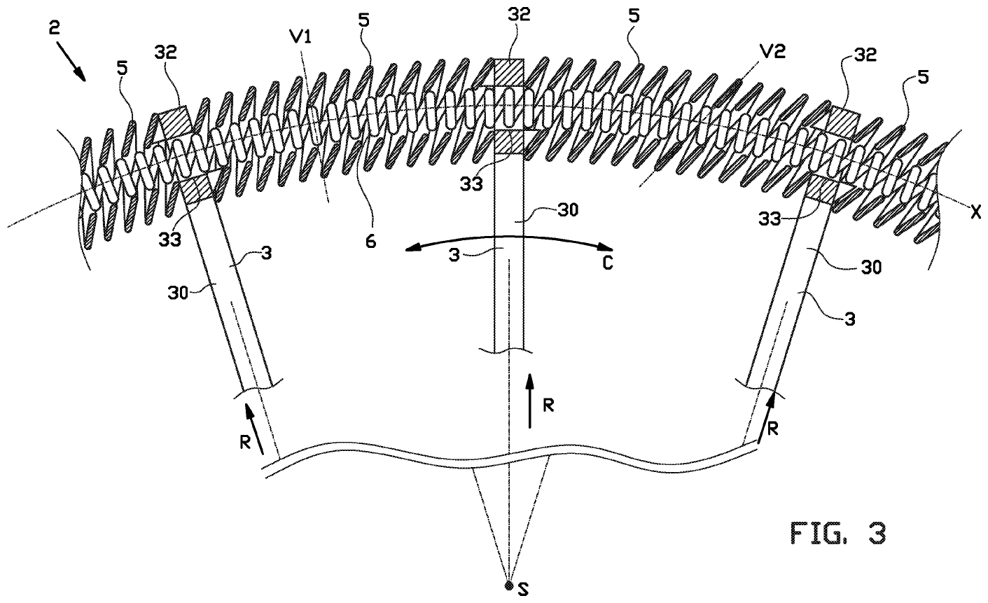

As best seen in FIGS. 2 and 3, the turn-up device 1 according to the invention comprises a plurality of rolling elements 5 extending in the circumferential direction C between the plurality of turn-up arms 3 for rolling over the tire components during the turning-up. Said rolling elements 5 are flexible about the central axis S to adapt to changes in the diameter of tire building drum 1 at the turn-up arms 3 as a result of the turn-up. In other words, the rolling elements 5 can flex to different curvatures matching different diameters or radii of the turn-up arms 3 during different stages of the turn-up. Moreover, the rolling elements 5 can optimally adapt to inconsistencies in the tire components and exert an evenly distributed pressing force across said tire components.

Additionally, the plurality of rolling elements 5 are expandable in the circumferential direction C from a compressed state, as shown in FIG. 2, to an expanded state, as shown in FIG. 3. In particular, the rolling elements 5 have a natural or uncompressed length that is significantly longer than the length as shown in FIG. 2. Hence, the rolling elements 5 are in a compressed state in FIG. 2 and are naturally biased to expand to or towards the expanded state as shown in FIG. 3. Hence, unlike known rigid pressing rollers, the rolling elements 5 according to the invention can automatically span or bridge the variable gap or spacing between the turn-up arms 3 in the circumferential direction C. Preferably, the rolling elements 5 are still slightly compressed in the maximum turn-up position to ensure that the rolling elements 5 are still biased.

In this exemplary embodiment, each rolling element 5 is formed as an outer or external spring, in particular an outer coil spring. The rolling element 5 is formed out of a continuous strip or wire that is wound over several windings to form a resilient helix. The rolling element 5 is made from a resilient material, e.g. a resilient metal or a resilient plastic material.

As best seen in FIG. 3, the strip is a substantially flat strip which has a substantially flat or quadrilateral cross section, in particular a rectangular cross section. In this exemplary embodiment, the corners of the rectangular cross section are slightly rounded to prevent that the rolling element 5 bites into the relatively soft material of the tire components.

As shown in FIG. 2, the rolling elements 5 have an outer diameter D1 and an inner diameter D2. Each rolling element 5 defines or has a hollow cavity with the inner diameter D2 extending through the rolling element 5 in the circumferential direction C.

As shown in FIGS. 2 and 3, the turn-up device 1 further comprises an annular support element 6 extending in the circumferential direction C along each of the plurality of turn-up arms 3. In other words, the support element 6 extends annularly around the plurality of turn-up arms 3 in the circumferential direction C. In particular, the annular support element 6 is supported by each of the turn-up arms 3. In this particular embodiment, each turn-up arm 3 is provided with a seat 33 at or near the second end 32 that is open in the radial direction R for receiving and supporting the annular support element 6. The annular support element 6 is continuous in the circumferential direction C, meaning that it forms a closed ring around the plurality of turn-up arms 3. The support element 6 may be continuous itself or may have two ends that are connected by a suitable connector (not shown) to form a continuous ring. Like the rolling elements 5, the annular support element 6 is flexible about the central axis S to adapt to changes in the diameter of tire building drum 1 at the turn-up arms 3 as a result of the turn-up.

Unlike the rolling elements 5, the annular support element 6 is not in a compressed state. Instead, the annular support element 6 is stretchable in the circumferential direction C from a contracted state, as shown in FIG. 2, to a stretched state, as shown in FIG. 3. The annular support element 6 has a natural or unstretched length that is equal to or shorter than the length of the annular support element 6 in the contracted state as shown in FIG. 2. Hence, the annular support element 6 has a natural tendency or bias to return from the stretched state, as shown in FIG. 3, to or towards the contracted state, as shown in FIG. 2. Consequently, the annular support element 6 could serve as a biasing element to return the turn-up arms 3 to an arms-down position. Preferably, the annular support element 6 is still slightly stretched in the arms-down position to ensure that the annular support element 6 remains biased.

In the spacing between the turn-up arms 3, the annular support element 6 extends in the circumferential direction C through each of the plurality of rolling elements 5. Preferably, the annular support element 6 has an outer diameter that is equal to or (slightly) smaller than the inner diameter D2 of the rolling elements 5. Hence, the annular support element 6 serves as a support shaft or axis for the rolling elements 5. In particular, the plurality of rolling elements 5 are rotatable with respect to the plurality of turn-up arms 3 about the annular support element 6. Because of the flexibility of the annular support element 6 about the central axis S, it can optimally adapt to the changing diameter of the tire building drum 1 at the turn-up arms 3 during the turning-up, such that each of the rolling elements 5 can be optimally supported and evenly pressed onto the tire components. Meanwhile, the rolling elements 5 can rotate freely about the annular support element 6, because both the rolling elements 5 and the annular support element 6 can adapt their shape to a position of least resistance.

In this exemplary embodiment, the annular support element 6 is an inner or internal spring, in particular an inner coil spring. The term ‘inner’ and ‘outer’ in relation to the springs merely refers to the relative location of the annular support element 6 and the rolling elements 5, respectively. The annular support element 6 is formed out of a continuous strip or wire that is wound over several windings to form a resilient helix. The annular support element 6 is made from a resilient material, e.g. a resilient metal or a resilient plastic material. In this exemplary embodiment, the annular support element 6 comprises a coiled wire with a circular or substantially circular cross section. Alternatively, the cross section may be adapted to optimize the contact between the annular support element 6 and the elements it supports. In particular, the circular cross section may be mechanically flattened on the external side of the annular support element 6 to form an at least partially flattened support surface. In a further embodiment (not shown), the cross section of the coiled wire may be more strip-like, e.g. rectangular like the strip of the previously discussed rolling elements 5.

As shown in FIGS. 2 and 3, the annular support element 6 has a first coil direction V1 and the rolling elements 5 have a second coil direction V2 that is opposite to the first coil direction V1. Hence, it can be prevented that the windings or coils of the annular support element 6 and the windings or coils of the rolling elements 5 supported thereon engage each other in the radial direction R.

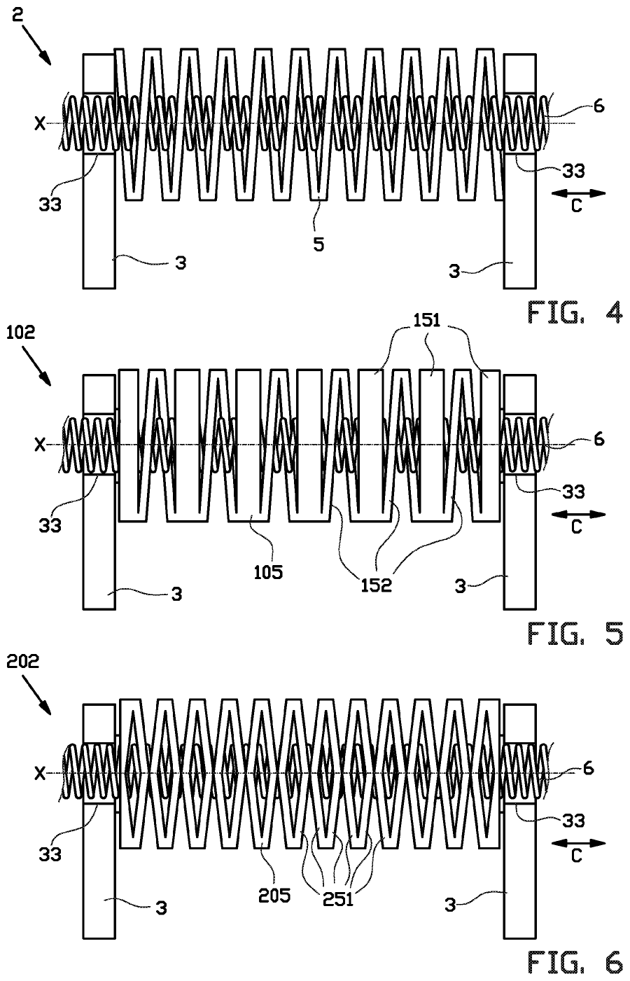

FIG. 4 shows the aforementioned turn-up device 1 from the top, meaning in a direction opposite to the radially outward direction R in FIG. 1.

FIGS. 5 and 6 show alternative turn-up devices 102, 202 according to a second embodiment and a third embodiment, respectively, of the invention. The alternative turn-up devices 102, 202, differ from the previously discussed turn-up device 2 in that their respective rolling elements 105, 205 are not, or at least not completely, coil shaped. Instead, the second embodiment as shown in FIG. 5 features a combination of rigid or substantially rigid ring-shaped members 151, e.g. roller members or bearings, interconnected by resiliently compressible spring members 152, e.g. coil spring members. Said members may be assembled or can alternatively be formed as a single piece, e.g. through casting or with the use of added manufacturing (3D printing). The third embodiment as shown in FIG. 6 features a rolling element 205 in the form of a wave spring having several wave plates 251 which are interconnected at two or more positions along the circumference of the rolling element 205.

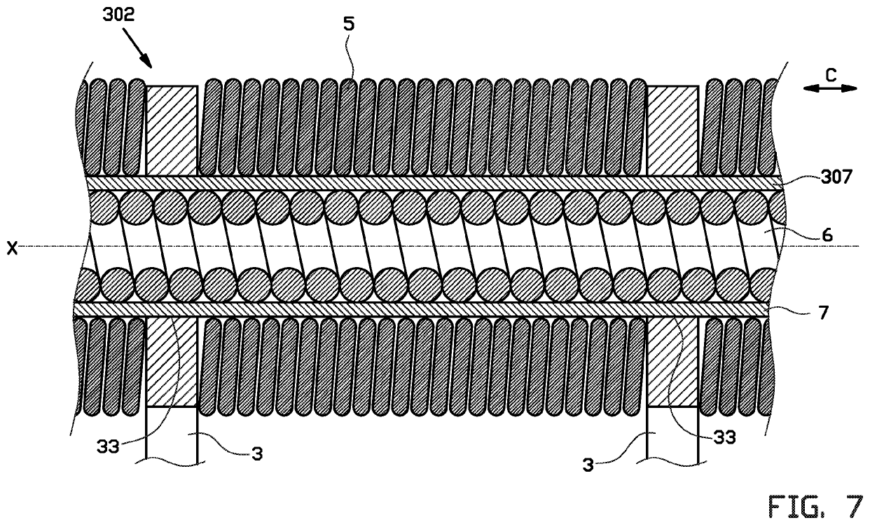

FIG. 7 shows a further alternative turn-up device 302 according to a fourth embodiment of the invention. Said further alternative turn-up device 302 features a separator 307 that extends around the annular support element 6 and separates the annular support element 6 from the plurality of rolling elements 5. The separator 307 prevents that the plurality of rolling elements 5 engage the annular support element 6, e.g. when both are formed as coil springs. Hence, the coil directions of the coil springs do not necessarily have to be opposite, provided that the separator 307 sufficiently separates both coils. The separator 307 can be an elastic encapsulation, e.g. a shrink foil or a shrink sleeve. It will be apparent to one skilled in the art that the separator 307 may be applied in any of the previously discussed embodiments.

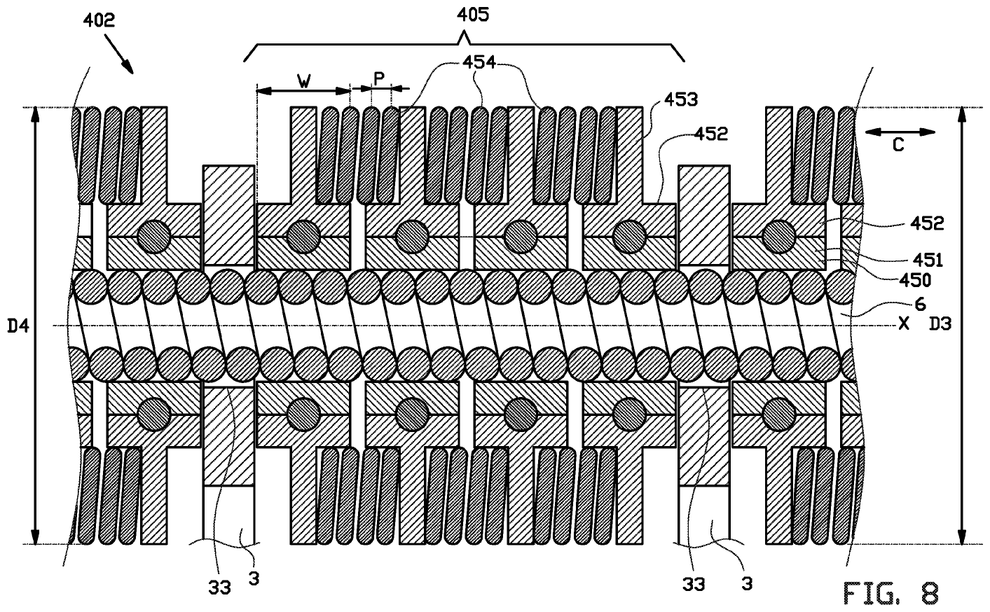

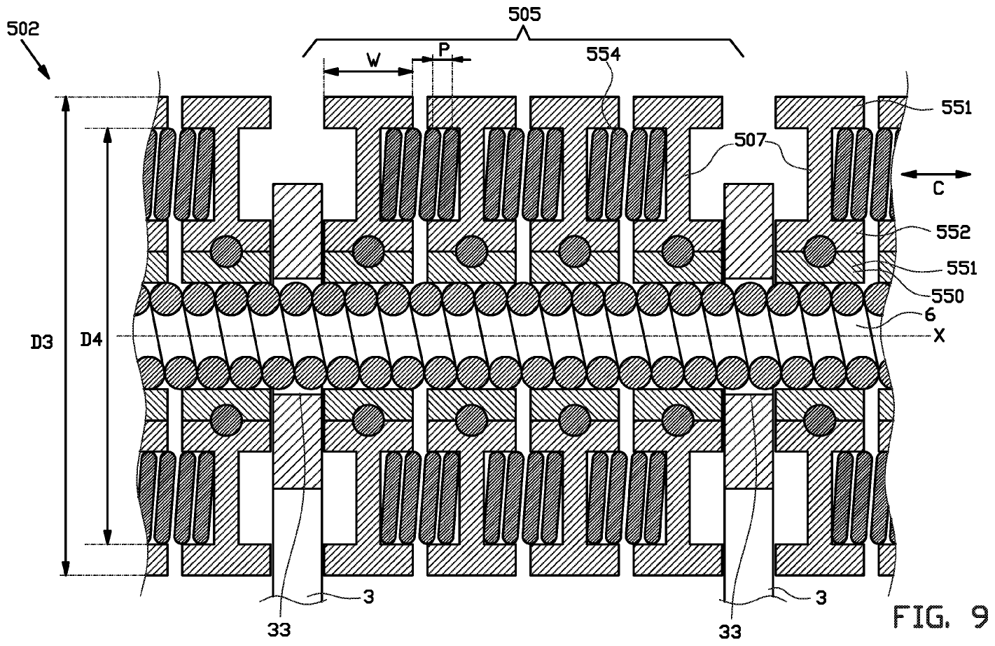

FIGS. 8 and 9 show further alternative turn-up devices 402, 502 according to a fifth embodiment and a sixth embodiment, respectively, of the invention. Said further alternative turn-up device 402, 502 solve the problem of their respective rolling elements 405, 505 engaging with the annular support element 6 in yet another different way. In particular, the embodiment as shown in FIG. 8 features a rolling element 405 with a plurality of bearings 450 and a plurality of intermediate springs 454 interconnecting said plurality of bearings 450. In this example, the bearings 450 are ball-bearings having an inner bearing ring 451 and an outer bearing ring 452. The outer bearing ring 452 is provided with a flange 453 for holding the intermediate springs 454. The plurality of bearings 450 are arranged for rotatably supporting the respective rolling element 405 on the annular support element 6. Alternatively, the bearings 450 can be made from a single piece. In that case, the bearings 450 simply slide over the annular support element 6.

As shown in FIG. 8, the intermediate springs 454 has a certain pitch P between the windings. Each bearing 450 has a width W in an axial direction tangent to the circumferential direction C that is at least equal to and preferably at least double the pitch P of the intermediate springs 450. Hence, the inner bearing ring 451 can be supported more reliably on the annular support element 6 than the intermediate springs 450, i.e. with less risk of the bearings 450 getting stuck between the windings of the annular support element 6.

In the embodiment as shown in FIG. 8, the plurality of bearings 450 has a first diameter D3 and the plurality of intermediate springs 454 has a second diameter D4 equal to or larger than the first diameter D3. Hence, the intermediate springs 454 are located flush with or (slightly) on the outside of the bearings 450 for together forming the outer surface of the rolling elements 405 that contacts the tire components.

In the alternative embodiment as shown in FIG. 9, the rolling element 505 again has a plurality of bearings 550 and intermediate springs 554 interconnecting said bearings 550. However, this time, the plurality of bearings 550 has a first diameter D3 larger than the second diameter D4 of the intermediate springs 554. Hence, in contrast to the previous embodiment, it is now the plurality of bearings 550 that forms the outer surface of the rolling elements 505 and contacts the tire components. Because of the width W of the bearings 550, the contact surface is more closed. Meanwhile, the intermediate springs 554 can provide the flexibility about the central axis. In this alternative embodiment, the flange is replaced by an outer bearing ring 552 that extends from the inner ring 551 to the outside of the intermediate springs 554.

In each of the previously discussed embodiments, the bearings 450, 550 and the intermediate springs 454, 554 may manufactured from a single piece, i.e. by added manufacturing techniques such as 3D printing which are known per se.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

1.-19. (canceled)

20. A turn-up device for a tire building drum, wherein the turn-up device comprises a plurality of turn-up arms distributed in a circumferential direction about a central axis and pivotable in a radial direction perpendicular to the central axis for turning-up tire components on the tire building drum,
wherein the turn-up device comprises a plurality of rolling elements extending in the circumferential direction between the plurality of turn-up arms for rolling over the tire components during the turning-up,
wherein the rolling elements are flexible about the central axis, wherein the turn-up device further comprises an annular support element extending in the circumferential direction along and supported by each of the plurality of turn-up arms,
wherein the annular support element extends in the circumferential direction through each of the plurality of rolling elements and is flexible about the central axis,
wherein the plurality of rolling elements are rotatable with respect to the plurality of turn-up arms about the annular support element.

21. The turn-up device according to claim 20, wherein the annular support element is stretchable in the circumferential direction from a contracted state to a stretched state,
wherein the annular support element is biased to contract from the stretched state to the contracted state.

22. The turn-up device according to claim 20, wherein the plurality of rolling elements are expandable in the circumferential direction from a compressed state to an expanded state.

23. The turn-up device according to claim 20, wherein the annular support element is an inner spring.

24. The turn-up device according to claim 23, wherein the inner spring is an inner coil spring.

25. The turn-up device according to claim 24, wherein the inner coil spring comprises a coiled wire with a circular cross section.

26. The turn-up device according to claim 20, wherein the plurality of rolling elements are outer springs.

27. The turn-up device according to claim 26, wherein the outer springs are outer coil springs.

28. The turn-up device according to claim 27, wherein the outer coil springs comprises a coiled strip having a quadrilateral cross section.

29. The turn-up device according to claim 28, wherein the coiled strip has a rectangular cross section.

30. The turn-up device according to claim 20, wherein the annular support element is an inner coil spring having a first coil direction,
wherein the plurality of rolling elements are outer coil springs having a second coil direction opposite to the first coil direction.

31. The turn-up device according to claim 20, wherein the plurality of rolling elements are wave springs.

32. The turn-up device according to claim 20, wherein each rolling element comprises a plurality of bearings and a plurality of intermediate springs interconnecting said plurality of bearings,
wherein the plurality of bearings are arranged for rotatably supporting the respective rolling element on the annular support element.

33. The turn-up device according to claim 32, wherein the intermediate springs have windings and a pitch between said windings,
wherein each bearing has a width in an axial direction tangent to the circumferential direction,
wherein said width is at least equal to or at least double the pitch of the intermediate springs.

34. The turn-up device according to claim 32, wherein the plurality of bearings has a first diameter and the plurality of intermediate springs has a second diameter equal to or larger than the first diameter.

35. The turn-up device according to claim 32, wherein the plurality of bearings has a first diameter and the plurality of intermediate springs has a second diameter smaller than the first diameter.

36. The turn-up device according to claim 20, wherein the turn-up device further comprises a separator that extends around the annular support element and separates the annular support element from the plurality of rolling elements.

37. The turn-up device according to claim 20, wherein each turn-up arm has a first end, a second end and an arm body extending in a longitudinal direction between the first end,
wherein the turn-up arm is arranged to be pivotable in the radial direction,
wherein the annular support element is supported by each of the plurality of turn-up arms at or near their respective second ends.

38. A tire building drum comprising the turn-up device according to claim 20.
